(19) United States
(12) Patent Application Publication
(10) Pub. No.: US 2005/0236420 A1
(43) Pub. Date: Oct. 27, 2005

(54) Container

(75) Inventors: Louise Jowett, Hull (GB); Judith Preuschen, Ludwigshafen (DE); Shaun Rymer, Hull (DE); Phil Shearsmith, Hull (GB); Ralf Wiedemann, Ludwigshafen (DE)

Correspondence Address: NORRIS, MCLAUGHLIN & MARCUS, 875 THIRD AVE, 18TH FLOOR, NEW YORK, NY, 10022, US

(73) Assignee: Reckitt Benckiser N.V., Hoofddorp (NL)

(21) Appl. No.: 10/505,798

(22) PCT Filed: Mar. 5, 2003
(86) PCT No.: PCT/GB03/00903

§ 371 Date: Jul. 13, 2005

(30) Foreign Application Priority Data
Mar. 6, 2002 (GB) 0205248.8

(51) Int. Cl. A47L 15/44; B67D 5/08; G07F 11/16; B65H 3/00; B65G 59/00; B65H 1/08; B67D 5/14

(52) U.S. Cl. 221/248; 221/232; 222/54

(57) ABSTRACT

Device for receiving and holding at least one detergent composition and/or additive and for dispensing and/or dosing said detergent composition and/or additive into an automatic dishwashing machine over a plurality of washing cycles, wherein the device comprises (i) a housing adapted to receive said detergent composition and/or additive; and (ii) means to, directly or indirectly, effect dispensing and/or dosing of said detergent composition and/or additive to be manually loaded with mechanical energy sufficient for more than one washing cycle by the user of the device, said mechanical energy being stored by locking said means in a loaded position through locking means, and said mechanical energy being released in a stepwise mode when said locking means is unlocked.

The present invention is related to a device for receiving and holding at least one detergent composition and/or additive and for dispensing and/or dosing said detergent composition and/or additive into an automatic dishwashing machine over a plurality of washing cycles as well as to a blister pack for use with such a device.

In known automatic dishwashing machines, the detergent, whether in powder, tablet or gel form, is usually filled manually by the user into the machine, in particular into a detergent holder, before each dishwashing operation. Because of the necessity of handling the dishwashing detergent each and every time when a dishwashing cycle is to be started, this filling process is inconvenient, even with detergents in tablet form, when the problem of exact metering of the detergent and possible spillage thereof is avoided, which is an additional problem for powder and gel detergents. Moreover, even with careful handling, direct contact of the detergent with the user's skin is difficult to avoid in the usual filling process, which is again inconvenient because of the nature of the detergent compositions.

From the prior art, a number of devices are known for dispensing and/or dosing detergent compositions into an automatic dishwashing machine over a plurality of washing cycles.

For example, EP 0 057 217 is related to an automatic dispenser device for powder detergents in a laundry or dishwashing machine with a feeding member in the form of a roller transforming a portion of the detergent from the supply to the wet cabin of the machine.

WO 88/06199 discloses a loader for holding and dispensing a washing additive including a receptacle in which there is a plurality of compartments each for receiving washing additive tablets. The compartments are at least partially defined by partitions forming part of a body, which is movable to bring each tablet adjacent to an opening provided in the receptacle. The tablets then pass through the opening to be dispensed, preferably under force of gravity.

Another device for dispensing of detergent tablets is described in DE 43 44 205 A1. The dosing device disclosed therein is mounted on the door of a dishwashing machine and loaded with a number of detergent tablets. The dosing device has an ejector for dispensing a single tablet each time the dishwashing machine is used. In a preferred embodiment, the dosing device has a reception shaft for receiving the detergent tablets one after the other, with the ejector being located at the bottom end of the shaft.

WO 01/07703 discloses a device for the dosed release of a detergent composition or additive into a dishwashing machine having a number of separate closed chambers for holding the detergent composition and means for opening the chambers, activated by conditions within the machine.

WO 01/25526 describes a device for dosing and/or dispensing a product into an appliance for treating laundry or dishes, said device comprising a housing with at least one compartment for containing said product, said compartment being closed by a corresponding cover and the device comprising means for storing energy and releasing it such that the product is released at a predetermined point in time during the washing cycle. Said means is preferably an electrical battery which may be connected with a mechanical actuator to open the cover which is manually loaded with mechanical energy when the consumer presses the cover prior to placing the device into the machine. The device is neither adapted nor intended for receiving and holding a plurality of unit doses and for individually dispensing thereof.

It is the object of the present invention to provide for an improved device for dispensing and/or dosing detergent compositions and/or additives into an automatic dishwashing machine in an automatic mode of operation over a plurality of washing cycles, wherein the supply of energy for this automatic mode of operation should be reliable, simple and effective.

This object is achieved with a device of the kind referred to hereinabove, wherein the device comprising (i) a housing adapted to receive said detergent composition and/or additive; and (ii) means to, directly or indirectly, effect dispensing and/or dosing of said detergent composition and/or additive, is to be manually loaded with mechanical energy sufficient for more than one washing cycle by the user of the device, said mechanical energy being stored by locking said means in a loaded position through locking means, and said mechanical energy being released in a stepwise mode when said locking means is unlocked.

In a preferred embodiment of the invention, said detergent composition and/or additive is introduced into said housing in the form of a plurality of unit doses each separately contained in a package or compartment thereof, means being provided in the device for opening said package or compartment or for at least partly ejecting said unit dose therefrom, said means to be loaded with mechanical energy being adapted to actuate said opening or ejecting means.

Preferably, said housing is adapted to receive a blister pack comprising said plurality of unit doses.

The means for ejecting the unit dose from said package or compartment may comprise an ejection ramp to act on at least one face of said package or compartment.

On the other hand, said means for opening said package or compartment may comprise a piercing or cutting means to penetrate at least one of the package or compartment walls.

In one preferred embodiment of the invention, said means to be manually loaded with mechanical energy comprises a spring motor adapted to be wound up by rotation for storing spring energy.

Preferably, the unlocking of the locking means is controlled by means reactive to a condition reached during the washing cycle of the machine, most preferably by means reactive to the specific temperature of the wash liquor.

In another embodiment, the unlocking of the locking means is time controlled.

In one preferred embodiment, the invention comprises means to allow access of water or wash liquor to said unit dose contained in the opened package or compartment or ejected therefrom within a controlled time period after opening thereof to allow dissolution of the unit dose into the water or wash liquor of the machine.

In a preferred embodiment, the device of the present invention is a portable device.

The invention is also related to a blister pack for use with a device according to the present invention.

Such blister pack is preferably in the form of a wheel-like plate with the unit doses arranged in at least one circle along the circumference thereof, or, alternatively, in the form of a row of unit doses arranged in a flexible loop.

The unit doses may be a detergent or detergent additive tablet or a detergent or detergent additive gel.

For the purpose of the present application, the term “unit dose” is used to mean the amount of detergent composition and/or additive required for one washing cycle of the automatic dishwashing machine. This amount can be provided for in any suitable form, such as powders, granules, gels, and liquids, optionally contained in pouches or formulated into tablets, and any mixtures thereof. For example, a unit dose may consist of a detergent powder composition and an additive in gel form contained in a pouch. For illustration purposes, but not restricted to this embodiment, the following more specific examples refer to a unit dose in the form of a tablet.

The device according to the present invention meets the objects as identified herein above in a surprisingly simple, effective and reliable way.

An important advantage of this device is that it enables the fully automatic dispensing of detergent compositions and/or additives, preferably as unit doses, over a plurality of washing cycles. Preferably, the operation of the device is automatic until the full set of unit doses in the blister pack has been ejected or dissolved therefrom. The device can then be loaded once again with mechanical energy for a further number of washing cycles when loading a fresh blister pack thereinto.

In a most preferred embodiment of the invention, the device is a portable device, i.e. is adapted to be placed into a dishwashing machine at any suitable place, for example in the plate space of the lower rack of a dishwashing machine. It is not required to specifically mount or fix the device within the machine and/or to connect it to the electronics or mechanics thereof. The device is also preferably self-standing meaning that it does not require any specific connection with the machine to work properly.

Although direct ejection or dissolution of the unit dose, such as a tablet, into the water or wash liquor of the machine is preferred, means of delay of such release or dissolution may be provided for by controlling the access of the water or wash liquor to the ejected unit dose or the opened package or compartment thereof. Means for realization thereof, such as a hinged/sliding door which regulates the access of wash liquor to the unit dose, are described in more detail in the parallel application concurrently filed herewith (GB Application No. 0205249.6).

For easier understanding, the invention is now described in more detail by way of example, with reference to the accompanying drawings in which:

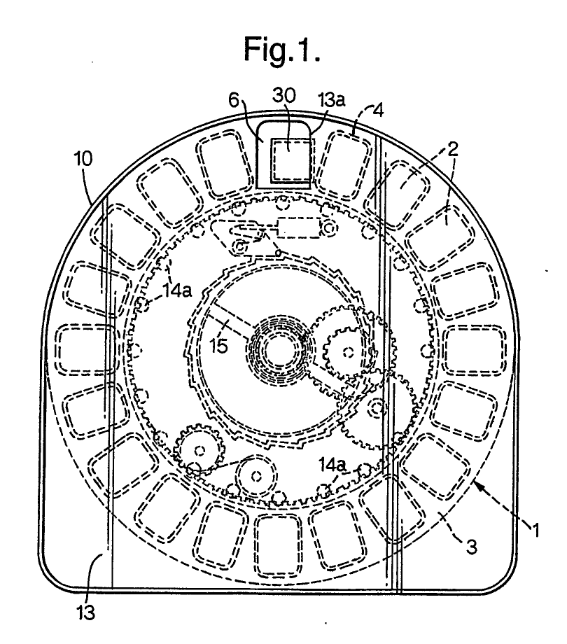

FIG. 1 is a plan view of one embodiment of the device according to the invention, loaded with a blister pack of detergent tablets;

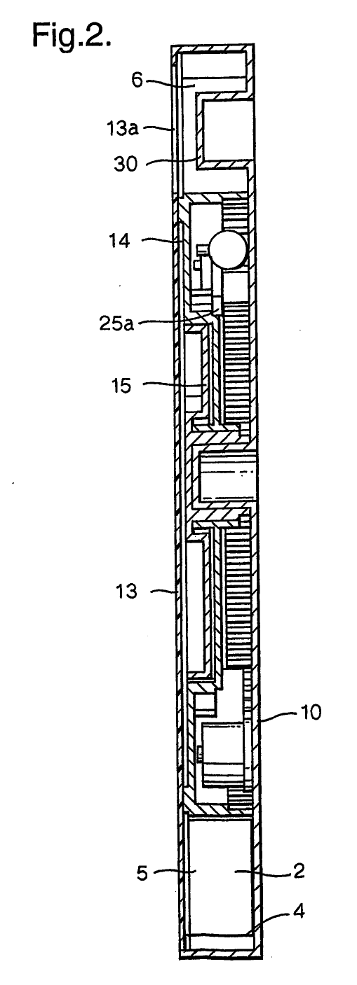

FIG. 2 is a cross-sectional view along line A-A of FIG. 1;

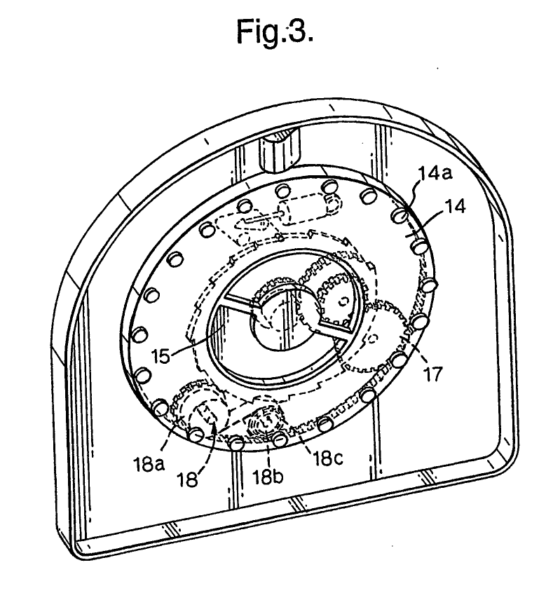

FIG. 3 is a plan view of the device of FIG. 1 with cover and blister pack removed;

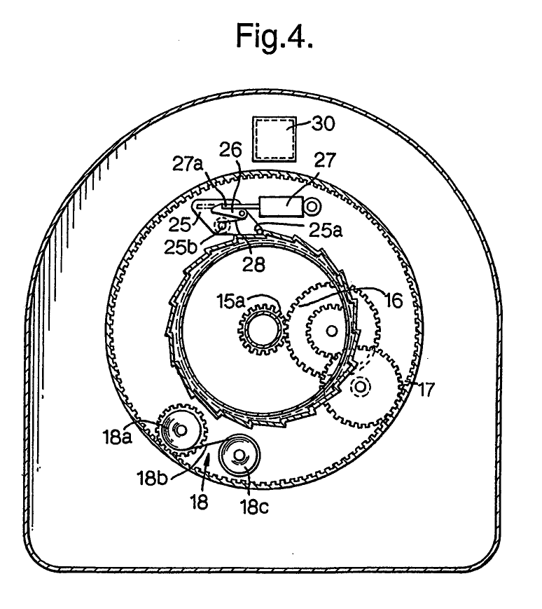

FIG. 4 is a plan view of the device of FIG. 1 with parts of the winder and of the carrier cut away to show the mechanism; and

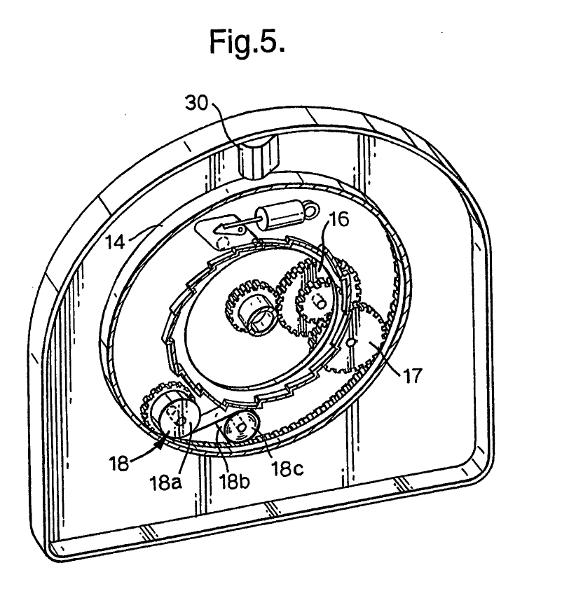

FIG. 5 is a perspective view of FIG. 4.

Now first referring to FIGS. 1 and 2, a blister pack 1 of a plurality of unit doses, namely tablets 2, is shown. This blister pack 1 is made of a circular wheel-like plate 3 of plastics material with deep-drawn compartments 4 along the circumference thereof to receive and hold the tablets. The plate 3 including the filled compartments 4 is covered by a foil 5 of plastics material. For ejection of the tablets from the compartments during operation of the device, weakening lines (not shown) or the like may be provided for around each single compartment 4. For reasons described later on, there is no compartment and no tablet at position 6 of the blister pack 1.

In an alternative embodiment of the blister pack (not shown) it may be comprised of a row of individually packaged unit doses formed into a loop before or when loading it into the device. In this case, the device of the present invention might have a different shape, i.e. not circular, but more elongate. The blister pack may e.g. have a form resembling a tank-track. Other forms and shapes of the blister pack and the device are within the scope of the present claims and may be considered as appropriate by someone skilled in the art.

Now referring to FIGS. 2 to 5, for activating the device before loading the blister pack 1 into the housing 10 of the device, with cover 13 removed, a spring motor 18 is wound up by manually rotating a winder 15 (gear part 15a), simultaneously acting as a central hub for the blister pack 1, when loaded, in a clockwise direction. This rotation is transferred through gears 16 and 17 to a carrier 14, which thus also rotates in a clockwise direction. A gear on drum 18a of the spring motor 18 is in mesh with the gear on carrier 14. Thus, drum 18a rotates clockwise winding spring 18b from drum 18c onto drum 18a. By that, mechanical energy is loaded into the spring motor 18 as the spring 18b always tries to wind itself back onto drum 18c.

When the spring motor 18 is fully wound up, the carrier 14 is urged to rotate in an anti-clockwise direction. The anti-clockwise rotation is controlled by a locking mechanism comprising a crank 25, a latch 26, and a thermal actuator 27. A pin 25a at the end of crank 25 is located in a “ratchet” track, which is part of the carrier 14. In the position shown in FIGS. 4 and 5, pin 25a prevents the carrier rotating anti-clockwise, as it would do under the force of spring motor 18.

After having activated the device by winding up the spring motor 18, blister pack 1 is placed on the carrier 14. The blister pack in this specific embodiment is divided into twenty segments, but there are only nineteen compartments for tablets, the remaining position 6, left blank. The blister pack 1 is placed on the carrier 14 so that this blank 6 is aligned with an ejection ramp 30. The twenty holes adjacent to each compartment 4 and to the blank 6 radially inwards are engaged with driving pegs 14a on the carrier 14. The cover 13 is then replaced and the loaded and activated device is placed in the dishwasher.

As the temperature in the dishwasher rises, the piston rod 27a in the thermal actuator 27 extends. The thermal actuator 27 may be of the wax pellet type in which the wax expands when the temperature rises causing the piston 27a to be pushed out. However, different types of thermal actuators may be used and are available for someone skilled in the art. The end of the rod 27a pushes against the hook edge of the latch 26 which can rotate on a pivot 25b, which is part of the crank 25. This rotation is resisted by the force provided by a spring member 28 pressing against the crank pivot 25b, which is part of the housing 10. As the piston rod 27a extends further, the crank 25 is forced to rotate anti-clockwise thus causing the pin 25a to move out of engagement with the ratchet track in the carrier 14. The carrier 14 then rotates anti-clockwise by virtue of the spring motor 18. As the carrier 14 rotates, the ratchet track guides the pin 25a inwards towards the center of the device and thus the crank 25 has to rotate clockwise. The latch 26 is forced out of engagement with the end of the piston rod 27a, which is still slowly extending as the temperature rises further. The carrier rotation is stopped when the pin 25a hits the next radial face of the ratchet track.

When the temperature drops, the piston 27a retracts and deflects the latch 26 on its way back thus leaving the mechanism reset for the next cycle.

While the carrier 14 and the blister pack 1 are rotating together, the next compartment 4 containing a tablet 2 is driven over the ramp 30, which pushes the tablet out through the foil 15 and an aperture 13a in the cover 13 and into the dishwasher.

There are, of course, other ways possible and within the reach of someone skilled in the art for loading mechanical energy into the device for actuating opening or ejecting means to allow individually dispensing of the unit doses from the blister pack.

Moreover, the device of the present invention is, however, not restricted to dispense unit doses of detergent compositions and/or additives. Rather, the concept is as well applicable to a dispensing and/or dosing of such compositions from a storage container holding the composition in any bulk form, such as powder, granules, gel or liquid. In such embodiments, the stepwise release of mechanical energy from the respective means when the locking means is unlocked, will actuate respective means for dosing or metering a predetermined portion of the detergent composition and/or additive into the machine, for example, by opening a respective outlet of the storage container into the machine for a predetermined time. Under the scope of the present invention, someone skilled in the art will easily be able to consider various ways of realization of this concept.

The features disclosed in the foregoing description, in the claims and/or drawings may both separately and in any combination thereof be material for realizing the invention in diverse forms thereof.

1. Device for receiving, holding and dispensing a detergent composition or additive into an automatic dishwashing machine over a plurality of washing cycles, the device comprising
(i) a housing adapted to receive said detergent composition which is introduced into said housing in the form of a plurality of unit doses (2) each separately contained in a package or compartment thereof;
(ii) a dosing means to effect dosing of said detergent composition, the means being capable of receiving mechanical energy, sufficient for a plurality of washing cycles, applied thereto by a user, the mechanical energy being stored by locking the dosing means in a loaded position with locking means, the mechanical energy being released in a stepwise mode when said locking means is unlocked; and
(iii) an opening means for opening said package or compartment or for at least partly ejecting said unit dose therefrom,
wherein the dosing means is adapted to actuate the opening means.

2. Device according to claim 1, wherein the housing is adapted to receive a blister pack comprising said plurality of unit doses.

3. Device according to claim 1, wherein the opening means comprises an ejection ramp to act on a face of said package or compartment.

4. Device according to claim 1, wherein the opening means comprises a piercing or cutting member to penetrate at least one of the package or compartment walls.

5. A device according to claim 1, wherein said dosing means comprises a spring motor adapted to be wound up by rotation for storing spring energy.

6. A device according to claim 1, wherein the unlocking of the locking means is controlled by means reactive to a condition reached during the washing cycle of the machine.

7. A device according to claim 6, wherein the unlocking of the locking means is controlled by means reactive to the specific temperature of the wash liquor.

8. A device according to claim 1, wherein the unlocking of the locking means is time controlled.

9. A device according to claim 1, comprising means to allow access of water/wash liquor to the unit dose within a controlled time period after opening thereof to allow dissolution of the unit dose into the water/wash liquor of the machine.

10. A portable, preferably self standing, device according to claim 1.

11. A blister pack for use with a device according to claim 1, wherein the blister pack is in the form of a wheel-like plate with a plurality of unit doses arranged in a circle along the circumference thereof.

12. A blister pack according to claim 11, the form of a row of unit doses arranged in a flexible loop.

13. A blister pack according to claim 11, wherein the unit dose is a detergent or detergent additive tablet.

14. A blister pack according to claim 11, wherein the unit dose is a detergent or detergent additive gel.

15. Device according to claim 2 wherein the opening means comprises an ejection ramp to act on a face of said package or compartment.

16. Device according to claim 2, wherein the opening means comprises a piercing or cutting member to penetrate at least one of the package or compartment walls.

17. A device according to claim 2 wherein said dosing means comprises a spring motor adapted to be wound up by rotation for storing spring energy.

18. A device according to claim 2 wherein the unlocking of the locking means is controlled by means reactive to a condition reached during the washing cycle of the machine.
